(19) United States
(12) Patent Application Publication
(10) Pub. No.: US 2006/0115152 A1
(43) Pub. Date: Jun. 1, 2006

(54) Image processing apparatus and method

(75) Inventor: Takashi Tsuchiya, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/242,087

(22) Filed: Oct. 4, 2005

(30) Foreign Application Priority Data
Nov. 29, 2004 (JP) 2004-344794

(51) Int. Cl. G06K 9/00

(52) U.S. Cl. 382/169

(57) ABSTRACT

The present invention reduces a delay of an output image which is originally caused by compression or emphasis processing when compressing the dynamic range of an image or emphasizing the contrast of an image, to obtain a processed-image output on real time. The present invention provides an image processing apparatus including a non-linear smoothening unit that non-linearly smoothens an input image signal in horizontal and vertical directions while storing an edge component of the input image signal whose signal level varies, a mixing unit that mixes the image signal non-linearly smoothened by the non-linear smoothening unit with the input image signal, a correction coefficient calculation unit that calculates a gain correction coefficient, based on a mixture image signal mixed by the mixing unit, and a compression processing unit that compresses a dynamic range of the input image signal by multiplying the input image signal by the gain correction coefficient calculated by the correction coefficient calculation unit.

### CROSS REFERENCES TO RELATED APPLICATIONS

The present invention contains subject matter related to Japanese Patent Application JP 2004-344794 filed in the Japanese Patent Office on Nov. 29, 2004, the entire contents of which being incorporated herein by reference.

### BACKGROUND OF THE INVENTION

1. Field of the Invention

The present invention relates to an image processing apparatus and an image processing method, and is applied to processing and recording of results of images picked up, for example, by a video camera, an electronic still camera or the like, image display by a liquid crystal display apparatus or the like, image processing and image synthesis by a personal computer or the like, and transfer of images by these devices.

2. Description of the Related Art

In the past, in various image processing circuits for an image pickup device or the like, various processings such as recording, reproduction, and the like are executed, compressing the dynamic range of images.

For this kind of processing of compressing the dynamic range, there have been a method of correcting gradation of the whole of an image and another method of correcting gradation of only the low-frequency component of an image. In the former method, gradation is corrected by gamma correction, knee correction, histogram equalization, and the like, to compress the dynamic range. In contrast, in the latter method, the dynamic range is compressed by gamma correction, knee correction, and the like.

In another method of effectively compressing the dynamic range of images, the signal level of an image signal is smoothened in the other parts than edges while storing edge components of which the signal level of the image signal varies. In accordance with the smoothened level, the compression ratio of the dynamic range of the image signal is determined. Corresponding to the ratio, the dynamic range of the image signal is compressed (for example, see Patent Document 1: Japanese Patent Application Laid-Open Publication No. 2001-275015).

In a still another method, the signal level of an image signal is smoothened in the other parts than edges while storing edge components of which the signal level of the image signal varies. In accordance with the smoothened level, the emphasis amount of the contrast of the image is determined. Corresponding to the amount, the contrast of the image is emphasized (for example, see Patent Document 2: Japanese Patent Application Laid-Open Publication No. 2001-298621).

In these methods, when compressing the dynamic range of an image, a smoothened image is used as a control signal. Therefore, it is possible to obtain a dynamic-range-compressed image with excellent visibility, which does not compress but maintains small amplitude components of the image. When the contrast of an image is emphasized, it is possible to obtain a contrast-emphasized image with also excellent visibility, in which small amplitude components of the image are further emphasized.

For example, as shown in FIG. 1, in a conventional image processing apparatus 200 which performs image compression/emphasis, input image signals Rin, Gin, and Bin of three channels are supplied to frame memories 301R, 301G, and 301B, and a coefficient generation section 310 for compression/emphasis. A coefficient G for compression/emphasis is generated based on the input mage signals Rin, Gin, and Bin, by the coefficient generation section 310. Delay image signals Rin′, Gin′, and Bin′ read from the frame memories 301R, 301G, and 301B are multiplied by the coefficient G, by the multipliers 302R, 302G, and 302B for the three channels, to obtain image signals Rout, Gout, and Bout subjected to a compression/emphasis processing.

In the coefficient generation section 310, the input image signals Rin, Gin, and Bin are mixed, by an RGB synthesis section 311, into a luminance signal Y of one channel. The luminance signal Y is smoothened in the horizontal direction by a horizontal smoothening section 312 and stored into a frame memory 313 while edge components of which the signal level varies are stored by a non-linear filter. The signal Sh stored in this frame memory 313 is read out therefrom in the vertical direction. The signal Sh is smoothened vertically by a vertical smoothening section 314 and stored into another frame memory 315 while edge components of which the signal level varies are also stored by a non-linear filter like in the case of the horizontal direction. The signal Shv stored in the frame memory 315 is read out therefrom in the horizontal direction and is converted, by a gain calculation section 316, into a coefficient G indicative of a gain for dynamic range compression or contrast emphasis.

On the other side, the input image signals Rin, Gin, and Bin are stored respectively in the frame memories 301R, 301G, and 301B in order that the coefficient G having a delay required for the horizontal and vertical filter processings described above is matched with a phase until all processing for calculating the coefficient G ends. After all smoothening processing in the coefficient generation section 310 ends and the coefficient G is calculated, the stored signals are read out in the horizontal direction as delayed image signals Rin′, Gin′, and Bin′ from the frame memories 301R, 301G, and 301B, at the timing of the calculation.

Further, the delayed image signals Rin′, Gin′, and Bin′ are multiplied by the coefficient G, by the multipliers 302R, 302G, and 302B of the three channels. As a result, image signals Rout, Gout, and Bout subjected to a compression/emphasis processing are obtained.

### SUMMARY OF THE INVENTION

However, for the methods disclosed in the Patent Documents 1 and 2, it is necessary to smoothen sufficiently an image when smoothening the other parts than edges while storing edge components of which the signal level of image signal varies, and thus, the image is required to be subjected to the horizontal and vertical filters, which have relatively large number of taps. Therefore, in image processing apparatuses using these methods, a delay is caused by filtering through the large smoothening filter from the start to end of processing. An image to be outputted comes with a relatively long delay. This delay of an output image causes a problem that deterioration in following response leads to worse operationality in operations that requires real-time performance, such as focusing, tracking of a target object, and the like.

For example, in the image processing apparatus 200 shown in FIG. 1, storing time of the frame memories 301R, 301G, and 301B becomes directly the delay of image output. Therefore, a delay of total two frames (or two fields in case of an interlaced video) is caused in image signals Rout, Gout, and Bout. One of the two frames is for rearrangement from the horizontal direction to the vertical direction in processing of a luminance signal and the other is for rearrangement from the vertical direction to the horizontal direction.

Hence, considering problems in conventional techniques as described above, it is desirable to reduce a delay of an output image which is originally caused by compression or emphasis processing when compressing the dynamic range of an image or emphasizing the contrast of an image, to obtain a processed-image output on real time.

The other objects of the present invention and advantages achieved by the present invention will be more apparent from the following detailed description of embodiments below.

According to the present invention, there is provided an image processing apparatus including: a non-linear smoothening means for non-linearly smoothening an input image signal in horizontal and vertical directions while storing an edge component of the input image signal whose signal level varies; a mixing means for mixing the image signal non-linearly smoothened by the non-linear smoothening means with the input image signal; a correction coefficient calculation means for calculating a gain correction coefficient, based on a mixture image signal mixed by the mixing means; and a compression processing means for compressing a dynamic range of the input image signal by multiplying the input image signal by the gain correction coefficient calculated by the correction coefficient calculation means.

According to the present invention, there is provided an image processing apparatus including: a non-linear smoothening means for non-linearly smoothening an input image signal in horizontal and vertical directions while storing an edge component of the input image signal whose signal level varies; a mixing means for mixing the image signal non-linearly smoothened by the non-linear smoothening means with the input image signal; and a difference signal emphasis means for subjecting, to gradation conversion, a difference between a mixture image signal mixed by the mixing means and the input image signal, and for adding the difference to an original not-smoothened image signal.

According to the present invention, there is an image processing apparatus including: a non-linear smoothening means for non-linearly smoothening an input image signal in horizontal and vertical directions while storing an edge component of the input image signal whose signal level varies; a mixing means for mixing the image signal non-linearly smoothened by the non-linear smoothening means with the input image signal; a correction coefficient calculation means for calculating a gain correction coefficient, based on a mixture image signal mixed by the mixing means; a compression processing means for compressing a dynamic range of the input image signal by multiplying the input image signal by the gain correction coefficient calculated by the correction coefficient calculation means; and a difference signal emphasis means for subjecting, to gradation conversion, a difference between the mixture image signal mixed by the mixing means and the input image signal, and for adding the difference to an original not-smoothened image signal.

According to the present invention, there is provided an image processing method including steps of: non-linearly smoothening the pixel value of an input image signal in horizontal and vertical directions while storing an edge component of the input image signal whose signal level varies; mixing the non-linearly smoothened image signal with the input image signal; calculating a gain correction coefficient, based on a mixture image signal obtained by the mixing; and compressing a dynamic range of the input image signal by multiplying the input image signal by the gain correction coefficient.

According to the present invention, there is provided an image processing method including steps of: non-linearly smoothening the pixel value of an input image in horizontal and vertical directions while storing an edge component of the input image signal whose signal level varies; mixing the non-linearly smoothened image signal with the input image signal; and subjecting, to gradation conversion, a difference between a mixture image signal obtained by the mixing and the input image signal, and adding the difference to an original not-smoothened image signal.

According to the present invention, there is provided an image processing method including steps of: non-linearly smoothening the pixel value of an input image in horizontal and vertical directions while storing an edge component of the input image signal whose signal level varies; mixing the non-linearly smoothened image signal with the input image signal; calculating a gain correction coefficient, based on a mixture image signal obtained by the mixing; and compressing a dynamic range of the input image signal by multiplying the input image signal by the gain correction coefficient, subjecting a difference between the mixture image signal obtained by the mixing and the input image signal, to gradation conversion, and adding the difference to an original not-smoothened image signal.

According to the present invention, there is provided an image processing apparatus including: a non-linear smoothening means for non-linearly smoothening an input image signal in horizontal and vertical directions while storing an edge component of the input image signal whose signal level varies; a mixing means for mixing the image signal non-linearly smoothened by the non-linear smoothening means with the input image signal; a first correction coefficient calculation means for calculating a gain correction coefficient, based on a mixture image signal mixed by the mixing means; a first compression processing means for compressing a dynamic range of the input image signal by multiplying the input image signal by the gain correction coefficient calculated by the correction coefficient calculation means; a storage means for storing temporarily the input image signal; a second correction coefficient calculation means for calculating a gain correction coefficient, based on the input image signal; and a second compression processing means for compressing the dynamic range of the input image signal by multiplying the input image signal read out from the storage means by the gain correction coefficient calculated by the second correction coefficient calculation means.

According to the present invention, there is provided an image processing apparatus including: a non-linear smoothening means for non-linearly smoothening an input image signal in horizontal and vertical directions while storing an edge component of the input image signal whose signal level varies; a mixing means for mixing the image signal non-linearly smoothened by the non-linear smoothening means with the input image signal; a first difference signal emphasis means for subjecting, to gradation conversion, a difference between a mixture image signal mixed by the mixing means and the input image signal, and for adding the difference to an original not-smoothened image signal; a storage means for storing temporarily the input image signal; and a second difference signal emphasis means for subjecting, to gradation conversion, a difference between the image signal non-linearly smoothened by the non-linear smoothening means and the input image signal read out from the storage means, and for adding the difference to an original not-smoothened image signal.

According to the present invention, there is provided an image processing apparatus including: a non-linear smoothening means for non-linearly smoothening an input image signal in horizontal and vertical directions while storing an edge component of the input image signal whose signal level varies; a mixing means for mixing the image signal non-linearly smoothened by the non-linear smoothening means with the input image signal; a first correction coefficient calculation means for calculating a gain correction coefficient, based on a mixture image signal mixed by the mixing means; a first compression processing means for compressing a dynamic range of the input image signal by multiplying the input image signal by the gain correction coefficient calculated by the correction coefficient calculation means; a first difference signal emphasis means for subjecting, to gradation conversion, a difference between the mixture image signal mixed by the mixing means and the input image signal, and for adding the difference to an original not-smoothened image signal; a storage means for storing temporarily the input image signal; a second correction coefficient calculation means for calculating a gain correction coefficient, based on the input image signal; a second compression processing means for compressing the dynamic range of the input image signal by multiplying the input image signal read out from the storage means by the gain correction coefficient calculated by the second correction coefficient calculation means; and a second difference signal emphasis means for subjecting, to gradation conversion, a difference between the image signal non-linearly smoothened by the non-linear smoothening means and the input image signal read out from the storage means, and for adding the difference to an original not-smoothened image signal.

According to the present invention, there is provided an image processing method including steps of: temporarily storing an input image signal and non-linearly smoothening the input image signal in horizontal and vertical directions while storing an edge component of the input image signal whose signal level varies; calculating a gain correction coefficient, based on the input image signal, and multiplying the temporarily stored input image signal by the gain correction coefficient, to output the input image signal with a dynamic range compressed; and calculating a gain correction coefficient, based on an image signal obtained by mixing the non-linearly smoothened image signal and the input image signal, and multiplying the input image signal by the gain correction coefficient, to output the input image signal with the dynamic range thereof compressed.

According to the present invention, there is provided an image processing method including steps of: temporarily storing an input image signal and non-linearly smoothening the input image signal in horizontal and vertical directions while storing an edge component of the input image signal whose signal level varies; subjecting, to gradation conversion, a difference between the non-linearly smoothened image signal and the temporarily stored input image signal, to output an original not-smoothened image signal added with the difference; and subjecting, to gradation conversion, a difference between the mixed image signal and the input image signal, to output an original not-smoothened image signal added with the difference.

According to the present invention, there is provided an image processing method including steps of: temporarily storing an input image signal and non-linearly smoothening the input image signal in horizontal and vertical directions while storing an edge component of the input image signal whose signal level varies; calculating a gain correction coefficient, based on the input image signal, multiplying the temporarily stored input image signal by the gain correction coefficient, to compress a dynamic range of the input image signal, and subjecting, to gradation conversion, a difference between the non-linearly smoothened image signal and the temporarily stored input image signal, to output an original not-smoothened image signal added with the difference; and calculating a gain correction coefficient, based on an image signal obtained by mixing the non-linearly smoothened image signal and the input image signal, multiplying the input image signal by the gain correction coefficient, to compress the dynamic range of the input image signal, and subjecting, to gradation conversion, a difference between the mixed image signal and the input image signal, to output an original not-smoothened image signal added with the difference.

According to the present invention, when compressing the dynamic range of an image or emphasizing the contrast thereof, delay of an output image which may originally be caused by a compression or emphasis processing can be reduced and a processed image output can be obtained on real time.

Therefore, if the present invention is applied to, for example, an image pickup device, a real-time processed image can be displayed on a monitor for operation, such as a view finder. Accordingly, operations such as focusing and tracking of a target object can be carried out with ease.

In addition, if the present invention is applied to a recording system such as a VTR, a processed image can be supplied without artifacts caused by correction while a real-time processed image is simultaneously displayed on a monitor for operations, such as a view finder.

Further, according to the present invention, the capacity of frame memories necessary for image processings can be reduced so that downsizing is achieved.

### BRIEF DESCRIPTION OF THE DRAWINGS

FIG. 1 is a block diagram showing an example of the structure of a conventional image processing apparatus which performs image compression/emphasis processing;

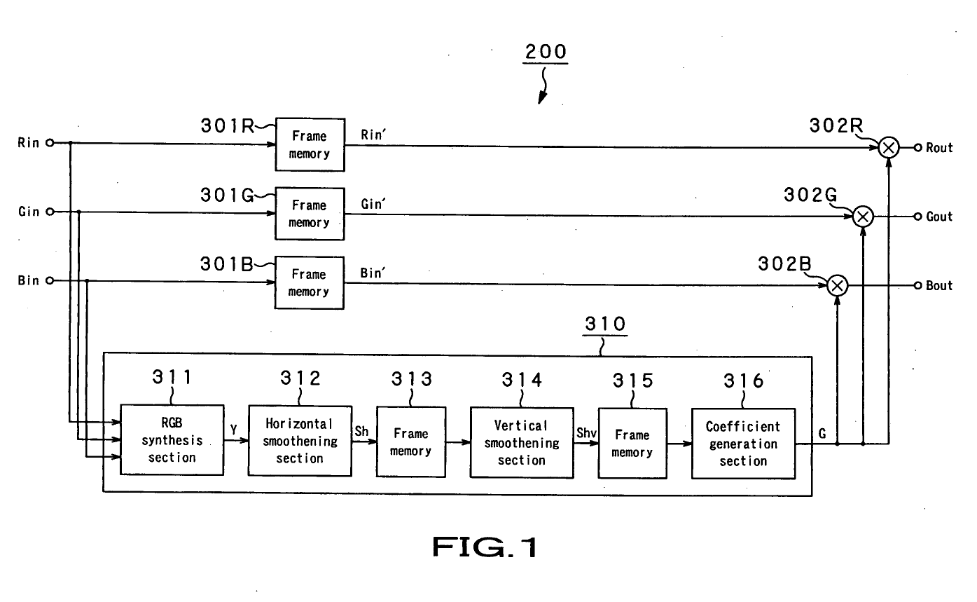

FIG. 2 is a block diagram showing the structure of an image pickup device to which the present invention is applied;

FIG. 3 is a block diagram showing the structure of a compression/emphasis processing section in the image pickup device;

FIG. 4 is block diagram showing a specific example of a correction coefficient generation section in the compression/emphasis processing section;

FIG. 5 is a graph schematically showing a smoothened fake-realtime image signal subjected to delay correction, which is obtained by a delay correction section in the compression/emphasis processing section; and

FIG. 6 is a block diagram showing another example of the structure of the compression/emphasis processing section in the image pickup device.

### DETAILED DESCRIPTION OF THE PREFERRED EMBODIMENTS

Hereinafter, embodiments of the present invention will be described in details with reference to the drawings. Needless to say, the present invention is not limited to the following embodiments but is arbitrarily modifiable without deviating from the subject matter of the present invention.

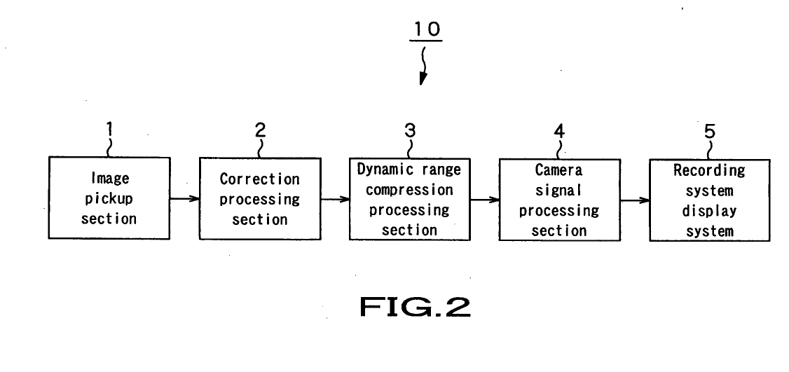

The present invention is applied to, for example, an image pickup device 10 having a structure as shown in FIG. 2.

The image pickup device 10 has: an image pickup section 1 which picks up and image of an object by a solid-state image pickup element such as a C-MOS image sensor, CCD (Charge Coupled Device) image sensor, or the like; a correction processing section 2 which is supplied with an image signal obtained as an image-pickup output signal by the image pickup section 1; a compression/emphasis processing section 3 which is supplied with an image signal subjected to a correction processing on a shading component by the correction processing section 2; and a camera signal processing section 4 which is supplied with an image signal subjected to a compression/emphasis processing by the compression/emphasis processing section 3. An image signal subjected to a camera signal processing such as a knee correction or gamma correction by the camera signal processing section 4 is supplied to a recording system like a VTR or a display system 5.

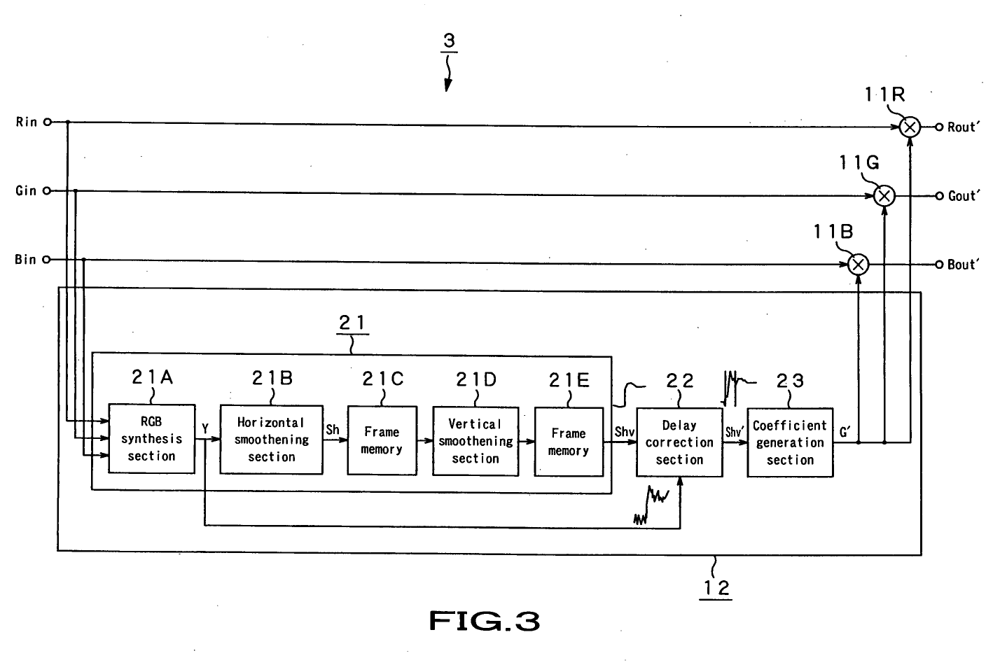

The compression/emphasis processing section 3 in this image pickup device 10 has multipliers 11R, 11G, and 11B for three channels, and a coefficient generation section 12 for compression/emphasis processing, for example, as shown in FIG. 3. The multipliers 11R, 11G, and 11B are supplied with input image signals Rin, Gin, and Bin for three channels, which have been subjected to a correction processing on a shading component by the correction processing section 2 described above. Based on the input image signals Rin, Gin, and Bin, the compression/emphasis processing section 3 generates a coefficient G′ for compression/emphasis processing by using the coefficient generation section 12, and multiplies the input image signals Rin, Gin, and Bin by the coefficient G′ by the multipliers 11R, 11G, and 11B described above, to obtain image signals Rout′, Gout′, and Bout′ subjected to a compression/emphasis processing.

The coefficient generation section 12 is constituted by a non-linear smoothing section 21, delay correction section 22, and correction coefficient calculation section 23. The non-linear smoothing section 21 is supplied with input image signals Rin, Gin, and Bin. The delay correction section 22 is supplied with an image signal Shy subjected to non-linear smoothening by the non-linear smoothing section 21. The correction coefficient calculation section 23 is supplied with the image signal Shy′ subjected to delay correction by the delay correction section 22.

The non-linear smoothing section 21 is arranged as follows. That is, an RGB synthesis section 21A, horizontal smoothing section 21B, frame memory 21C, vertical smoothing section 21D, and frame memory 21E, which are cascaded, smoothen non-linearly the input image signals Rin, Gin, and Bin in the horizontal and vertical directions while storing edge components of which the signal levels of the input image signals Rin, Gin, and Bin vary.

That is, in the non-linear smoothing section 21, the input image signals Rin, Gin, and Bin are synthesized by the RGB synthesis section 21A into a luminance signal Y of one channel. The luminance signal Y is smoothened in the horizontal direction by the horizontal smoothing section 21B and stored into the frame memory 21C while storing edge components of which the signal level varies. The signal Sh stored in the frame memory 21C is read out in the vertical direction from this memory 21C. The signal read out is smoothened in the vertical direction by the vertical smoothing section 21D and is stored into the frame memory 21E while edge components of which the signal level varies are stored by the non-linear filter similar to that for the horizontal direction. This signal Shv stored in the frame memory 21E is read out in the horizontal direction from the frame memory 21E and is supplied, as an image signal Shv smoothened non-linearly in the horizontal and vertical directions, to the delay correction section 22 described above.

The delay correction section 22 is supplied with the luminance signal Y generated by the RGB synthesis section 21A of the non-linear smoothing section 21, i.e., an image signal before being non-linearly smoothened in the horizontal and vertical directions.

The delay correction section 22 mixes the image signal Shv non-linearly smoothened by the non-linear smoothing section 21 and the image signal before being non-linearly smoothened, i.e., the luminance signal Y, to generate an image signal Shv′ subjected to delay correction. The delay correction section 22 supplies the image signal Shv′ to the correction coefficient calculation section 23.

Between the input signal Shv smoothened and delayed and the input signal Y before being smoothened and delayed, another difference in signal levels occurs in addition to the difference as to whether the signal has been smoothened or not because an object has moved during the time period required for the smoothening. However, the delay correction section 22 mixes the not-delayed signal Y before being smoothened with the smoothened and delayed signal Shv, in accordance with the absolute value of the level difference. Thus, the smoothened fake-realtime signal Shv′ is generated.

Suppose now that the absolute value of the level difference between the two input singals Shv and Y is mv:
mv=|Shv−Y| (1)
Also suppose that the mixing ratio between Shv and Y at the value mv is α Then, a signal Smix which is internally divided into Shv and Y in accordance with mv is generated.
α=0.0 (mv≦level1)
α=1.0 (mv≧level2)
α=(mv−level1)/(level2−levlel1)(level1<mv<level2)
Smix=α×Y+(1−α)×Shv (2)

That is, when mv is equal to or smaller than the level 1, i.e., when the difference between the smoothened and delayed signal Shv and the not-delayed signal Y before smoothening is small, the smoothened signal Shv is generated. When mv is equal to or greater than the level 2, i.e., when the difference between the smoothened and delayed signal Shv and the not-delayed signal Y before smoothening is great, the real-time signal Y is generated. When the level is between the level 1 and the level 2, the signal Smix which is internally divided into Shv and Y in accordance with mv is generated.

However, the signal Smix that contains Y at a high mixing ratio has not or insufficiently been smoothened. Therefore, smoothening filtering is effected after generation of the Smix, to raise more or less the smoothening effect. In this case, smoothening is carried out by use of a non-linear filter which smoothens a signal while storing edge components of which the signal level varies. The signal which has passed through this filter is outputted as a smoothened fake-realtime signal Shv′.

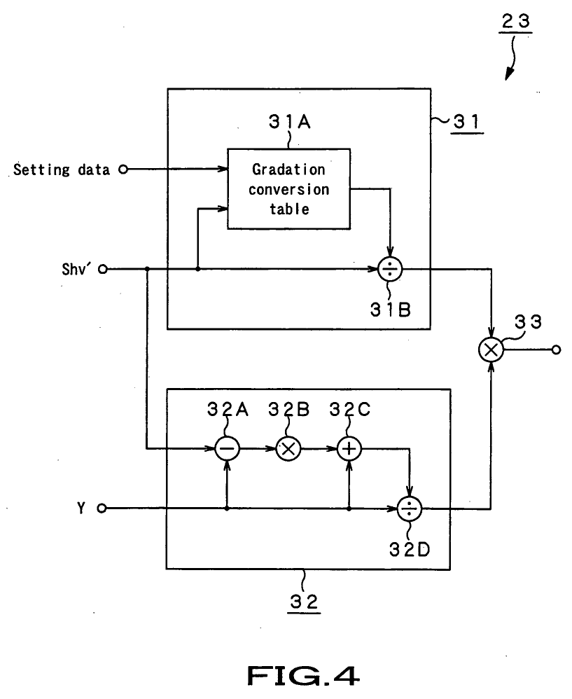

A specific example of the structure of the correction coefficient generation section 23 will be described with reference to FIG. 4.

The correction coefficient generation section 23 shown in FIG. 4 is constituted by a first coefficient calculation section 31 for compression processing, a second coefficient calculation section 32 for contrast emphasis processing, and a multiplier 33 which integrates correction coefficients calculated by the coefficient calculation sections 31 and 32.

The first coefficient calculation section 31 is constituted by, for example, a gradation conversion table 31A and a divider 31B. A ratio between a gradation conversion signal and the image signal Shv′ is obtained by the divider 31B wherein the gradation conversion signal is read out from the gradation conversion table 31A using as an address the image signal Shv′ subjected to delay correction by the delay correction section 22. Thus, the first coefficient calculation section 31 calculates a gain correction coefficient gdc for compression processing. Also, the first coefficient calculation section 31 calculates the gain correction coefficient gdc to perform, for example, compression processing similar to the Patent Document 1 described previously.

The second coefficient calculation section 32 is constituted by: a subtracter 32A which calculates a difference between the image signal Shv′ subjected to delay correction by the delay correction section 22 and the not-delayed input signal Y before smoothening; a multiplier 32B which multiplies the difference signal calculated by the subtracter 32A by a gain coefficient, to perform gradation conversion; an adder 32C which performs difference signal emphasis to add the difference signal subjected to gradation conversion by the multiplier 32B, to the not-delayed input signal Y before smoothening; and a divider 32D which calculates the ratio between the signal subjected to difference signal emphasis by the adder 32C and the not-delayed input signal Y before smoothening. This second coefficient calculation section 32 calculates a gain correction coefficient gcc for contrast emphasis processing to perform difference signal emphasis in which the difference between the image signal Shv′ subjected to delay correction by the delay correction section 22 and the not-delayed input signal Y before smoothening is subjected to gradation conversion and added to the original image signal not smoothened. Note that this second coefficient calculation section 32 calculates the gain correction coefficient gcc to perform, for example, contrast emphasis processing similar to the Patent Document 2.

Further, the multiplier 33 calculates a gain coefficient G′ for compression/emphasis processing by multiplication by the gain correction coefficients gdc and gcc calculated by the coefficient calculation sections 31 and 32.

Thus, the coefficient G′ for compression/emphasis processing, which is generated on the basis of input image signals Rin, Gin, and Bin by the coefficient generation section 12, is supplied to the above-described multipliers 11R, 11G, and 11B of three channels. These multipliers are supplied with input image signals Rin, Gin, and Bin of three channels whose shading components and the like have been subjected to correction processing by the correction processing section 2.

Further, the multipliers 11R, 11G, and 11B of three channels multiply the input image signals Rin, Gin, and Bin by the gain coefficient G′ generated by the coefficient generation section 12 for compression/emphasis processing, and output image signals Rout′, Gout′, and Bout′ subjected to compression/emphasis processing.

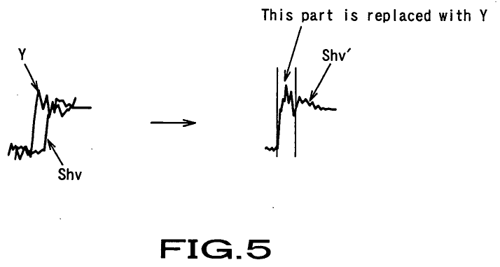

That is, by means of the delay correction section 22, the compression/emphasis processing section 3 in the image pickup device 10 corrects the image signal Shv smoothened in the horizontal and vertical directions and delayed by two frames, by use of the not-delayed luminance signal Y before smoothening, as shown in FIG. 5. The compression/emphasis processing section 3 thus creates a smoothened fake-realtime image signal Shv′ and multiplies the not-delayed input image signals Rin, Gin, and Bin by a coefficient G′ for compression/emphasis processing, which is created from the image signal Shv′, thereby to obtain image signals Rout′, Gout′, and Bout′ subjected to compression/emphasis processing on real time.

By adopting this structure, not only an processed image output can be obtained on real time but also it is unnecessary to provide a frame memory on main signal lines. Simultaneously, the circuit scale can be reduced.

The compression/emphasis processing section 3 in this image pickup device 10 mixes the non-linearly smoothened image signal Shv and the image signal Y before being non-linearly smoothened, by means of the delay correction section 22, thereby to generate an image signal Shv′ subjected to delay correction. In the correction coefficient generation section 23, the first coefficient calculation section 31 calculates a gain correction coefficient gdc for compression processing is calculated, based on the image signal Shv′ subjected to delay correction. The second coefficient calculation section 32 calculates a gain correction coefficient gcc for contrast emphasis processing to perform difference signal emphasis in which the difference between the image signal Shv′ subjected to delay correction and the not-delayed input signal Y before smoothening is subjected to gradation conversion and added to the original image signal not smoothened. Each of the gain correction coefficients gds and gcc is subjected to multiplication by the multiplier 33 to obtain a gain coefficient G′ for compression/emphasis processing. The input image signals Rin, Gin, and Bin are multiplied by the gain coefficient G′ for compression/emphasis processing by the multipliers 11R, 11G, and 11B of three channels, thereby to obtain image signals Rout′, Gout′, and Bout′ subjected to compression/emphasis processing. However, image signals Rout′, Gout′, and Bout′ subjected only to compression processing may be obtained by omitting the second coefficient calculation section 32 and multiplier 33. Alternatively, image signals Rout′, Gout′, and Bout′ subjected only to emphasis processing may be obtained by omitting the first coefficient calculation section 31 and multiplier 33.

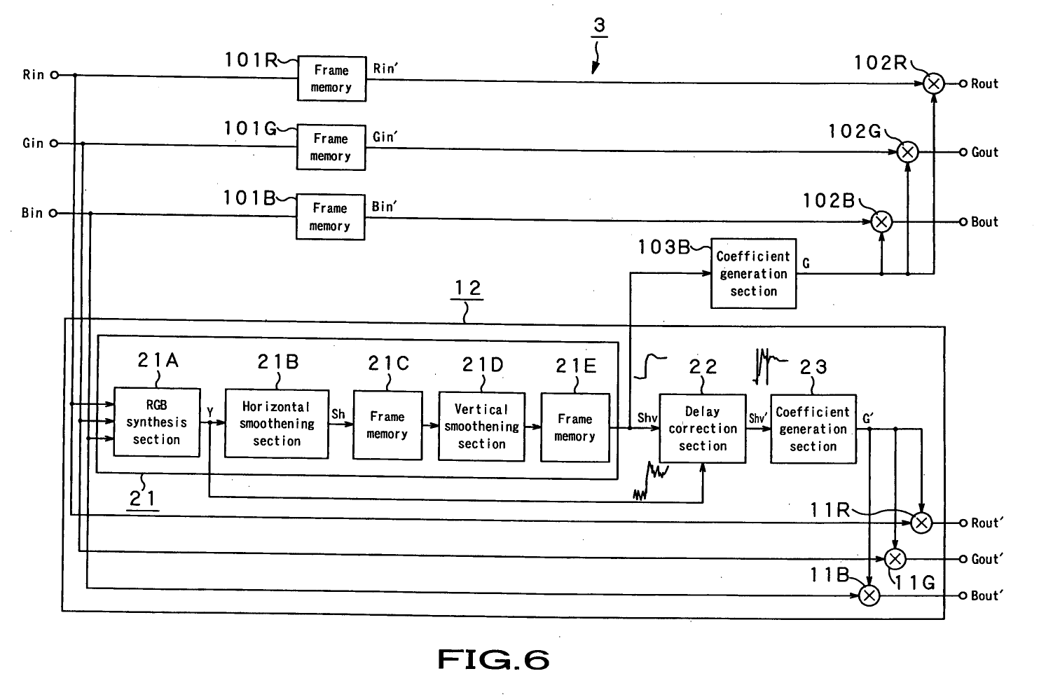

Further, in addition to the structure shown in FIG. 3, the compression/emphasis processing section 3 in the image pickup device 10 may be provided with multipliers 102R, 102G, and 102B and a correction coefficient calculation section 116, as shown in FIG. 6. The multipliers 102R, 102G, and 102B are supplied with the input image signals Rin, Gin, and Bin of three channels through frame memories 101R, 101G, and 101B. The correction coefficient calculation section 116 generates a coefficient G for compression/emphasis processing, based on the image signal Shv non-linearly smoothened in the horizontal and vertical directions by the non-linear smoothening section 21. Delayed image signals Rin′, Gin′, and Bin′ read from the frame memories 101R, 101G, and 101B may be multiplied by the coefficient G for compression/emphasis processing, which is calculated by the correction coefficient calculation section. In this manner, image signals Rout, Gout, and Bout subjected to compression/emphasis processing may be outputted.

By adopting this structure, the image pickup device 10 does not perform correction on image signals for a recording system such as a VTR but can supply the recording system with image signals Rout, Gout, and Bout free from artifacts caused by correction. Simultaneously, corrected image signals Rout′, Gout′, and Bout′ can be supplied to a view finder for operation of the image pickup device 10, to display real-time processed images.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
non-linear smoothening means for non-linearly smoothening an input image signal in horizontal and vertical directions while storing an edge component of the input image signal whose signal level varies;
mixing means for mixing the image signal non-linearly smoothened by the non-linear smoothening means with the input image signal;
correction coefficient calculation means for calculating a gain correction coefficient, based on a mixture image signal mixed by the mixing means; and
compression processing means for compressing a dynamic range of the input image signal by multiplying the input image signal by the gain correction coefficient calculated by the correction coefficient calculation means.

2. An image processing apparatus comprising:
non-linear smoothening means for non-linearly smoothening an input image signal in horizontal and vertical directions while storing an edge component of the input image signal whose signal level varies;
mixing means for mixing the image signal non-linearly smoothened by the non-linear smoothening means with the input image signal; and
difference signal emphasis means for subjecting, to gradation conversion, a difference between a mixture image signal mixed by the mixing means and the input image signal, and for adding the difference to an original not-smoothened image signal.

3. An image processing apparatus comprising:
non-linear smoothening means for non-linearly smoothening an input image signal in horizontal and vertical directions while storing an edge component of the input image signal whose signal level varies;
mixing means for mixing the image signal non-linearly smoothened by the non-linear smoothening means with the input image signal;
correction coefficient calculation means for calculating a gain correction coefficient, based on a mixture image signal mixed by the mixing means;
compression processing means for compressing a dynamic range of the input image signal by multiplying the input image signal by the gain correction coefficient calculated by the correction coefficient calculation means; and
difference signal emphasis means for subjecting, to gradation conversion, a difference between the mixture image signal mixed by the mixing means and the input image signal, and for adding the difference to an original not-smoothened image signal.

4. An image processing method comprising steps of:
non-linearly smoothening the pixel value of an input image in horizontal and vertical direction while storing an edge component of the input image signal whose signal level varies;
mixing the non-linearly smoothened image signal with the input image signal;
calculating a gain correction coefficient, based on a mixture image signal obtained by the mixing; and
compressing a dynamic range of the input image signal by multiplying the input image signal by the gain correction coefficient.

5. An image processing method comprising steps of:
non-linearly smoothening the pixel value of an input image in horizontal and vertical direction while storing an edge component of the input image signal whose signal level varies;
mixing the non-linearly smoothened image signal with the input image signal; and
subjecting, to gradation conversion, a difference between a mixture image signal obtained by the mixing and the input image signal, and adding the difference to an original not-smoothened image signal.

6. An image processing method comprising steps of:
non-linearly smoothening the pixel value of an input image in horizontal and vertical direction while storing an edge component of the input image signal whose signal level varies;
mixing the non-linearly smoothened image signal with the input image signal;
calculating a gain correction coefficient, based on a mixture image signal obtained by the mixing; and
compressing a dynamic range of the input image signal by multiplying the input image signal by the gain correction coefficient, subjecting a difference between the mixture image signal obtained by the mixing and the input image signal, to gradation conversion, and adding the difference to an original not-smoothened image signal.

7. An image processing apparatus comprising:
non-linear smoothening means for non-linearly smoothening an input image signal in horizontal and vertical directions while storing an edge component of the input image signal whose signal level varies;
mixing means for mixing the image signal non-linearly smoothened by the non-linear smoothening means with the input image signal;
first correction coefficient calculation means for calculating a gain correction coefficient, based on a mixture image signal mixed by the mixing means;
first compression processing means for compressing a dynamic range of the input image signal by multiplying the input image signal by the gain correction coefficient calculated by the correction coefficient calculation means;
storage means for storing temporarily the input image signal;
second correction coefficient calculation means for calculating a gain correction coefficient, based on the input image signal; and
second compression processing means for compressing the dynamic range of the input image signal by multiplying the input image signal read out from the storage means by the gain correction coefficient calculated by the second correction coefficient calculation means.

8. An image processing apparatus comprising:
non-linear smoothening means for non-linearly smoothening an input image signal in horizontal and vertical directions while storing an edge component of the input image signal whose signal level varies;
mixing means for mixing the image signal non-linearly smoothened by the non-linear smoothening means with the input image signal;
first difference signal emphasis means for subjecting, to gradation conversion, a difference between a mixture image signal mixed by the mixing means and the input image signal, and for adding the difference to an original not-smoothened image signal;
storage means for storing temporarily the input image signal; and
second difference signal emphasis means for subjecting, to gradation conversion, a difference between the image signal nonlinearly smoothened by the non-linear smoothening means and the input image signal read out from the storage means, and for adding the difference to an original not-smoothened image signal.

9. An image processing apparatus comprising:
non-linear smoothening means for non-linearly smoothening an input image signal in horizontal and vertical directions while storing an edge component of the input image signal whose signal level varies;
mixing means for mixing the image signal non-linearly smoothened by the non-linear smoothening means with the input image signal;
first correction coefficient calculation means for calculating a gain correction coefficient, based on a mixture image signal mixed by the mixing means;
first compression processing means for compressing a dynamic range of the input image signal by multiplying the input image signal by the gain correction coefficient calculated by the correction coefficient calculation means;
first difference signal emphasis means for subjecting, to gradation conversion, a difference between the mixture image signal mixed by the mixing means and the input image signal, and for adding the difference to an original not-smoothened image signal;
storage means for storing temporarily the input image signal;
second correction coefficient calculation means for calculating a gain correction coefficient, based on the input image signal;
second compression processing means for compressing the dynamic range of the input image signal by multiplying the input image signal read out from the storage means by the gain correction coefficient calculated by the second correction coefficient calculation means; and
second difference signal emphasis means for subjecting, to gradation conversion, a difference between the image signal non-linearly smoothened by the non-linear smoothening means and the input image signal read out from the storage means, and for adding the difference to an original not-smoothened image signal.

10. An image processing method comprising steps of:
temporarily storing an input image signal and non-linearly smoothening the input image signal in horizontal and vertical directions while storing an edge component of the input image signal whose signal level varies;
calculating a gain correction coefficient, based on the input image signal, and multiplying the temporarily stored input image signal by the gain correction coefficient, to output the input image signal with a dynamic range compressed; and
calculating a gain correction coefficient, based on an image signal obtained by mixing the non-linearly smoothened image signal and the input image signal, and multiplying the input image signal by the gain correction coefficient, to output the input image signal with the dynamic range thereof compressed.

11. An image processing method comprising steps of:
temporarily storing an input image signal and non-linearly smoothening the input image signal in horizontal and vertical directions while storing an edge component of the input image signal whose signal level varies;
subjecting, to gradation conversion, a difference between the non-linearly smoothened image signal and the temporarily stored input image signal, to output an original not-smoothened image signal added with the difference; and
subjecting, to gradation conversion, a difference between the mixed image signal and the input image signal, to output an original not-smoothened image signal added with the difference.

12. An image processing method comprising steps of:
temporarily storing an input image signal and non-linearly smoothening the input image signal in horizontal and vertical directions while storing an edge component of the input image signal whose signal level varies;
calculating a gain correction coefficient, based on the input image signal, multiplying the temporarily stored input image signal by the gain correction coefficient, to compress a dynamic range of the input image signal, and subjecting, to gradation conversion, a difference between the non-linearly smoothened image signal and the temporarily stored input image signal, to output an original not-smoothened image signal added with the difference; and
calculating a gain correction coefficient, based on an image signal obtained by mxing the non-linearly smoothened image signal and the input image signal, multiplying the input image signal by the gain correction coefficient, to compress the dynamic range of the input image signal, and subjecting, to gradation conversion, a difference between the mixed image signal and the input image signal, to output an original not-smoothened image signal added with the difference.

13. An image processing apparatus comprising:
a non-linear smoothening unit that non-linearly smoothens an input image signal in horizontal and vertical directions while storing an edge component of the input image signal whose signal level varies;
a mixing unit that mixes the image signal non-linearly smoothened by the non-linear smoothening unit with the input image signal;
a correction coefficient calculation unit that calculates a gain correction coefficient, based on a mixture image signal mixed by the mixing unit; and
a compression processing unit that compresses a dynamic range of the input image signal by multiplying the input image signal by the gain correction coefficient calculated by the correction coefficient calculation unit.

14. An image processing apparatus comprising:
a non-linear smoothening unit that non-linearly smoothens an input image signal in horizontal and vertical directions while storing an edge component of the input image signal whose signal level varies;
a mixing unit that mixes the image signal non-linearly smoothened by the non-linear smoothening unit with the input image signal; and
a difference signal emphasis unit that subjects, to gradation conversion, a difference between a mixture image signal mixed by the mixing unit and the input image signal, and that adds the difference to an original not-smoothened image signal.

15. An image processing apparatus comprising:
a non-linear smoothening unit that non-linearly smoothens an input image signal in horizontal and vertical directions while storing an edge component of the input image signal whose signal level varies;
a mixing unit that mixes the image signal non-linearly smoothened by the non-linear smoothening unit with the input image signal;
a correction coefficient calculation unit that calculates a gain correction coefficient, based on a mixture image signal mixed by the mixing unit;
a compression processing unit that compresses a dynamic range of the input image signal by multiplying the input image signal by the gain correction coefficient calculated by the correction coefficient calculation unit; and
a difference signal emphasis unit that subjects, to gradation conversion, a difference between the mixture image signal mixed by the mixing unit and the input image signal, and that adds the difference to an original not-smoothened image signal.

16. An image processing apparatus comprising:
a non-linear smoothening unit that non-linearly smoothens an input image signal in horizontal and vertical directions while storing an edge component of the input image signal whose signal level varies;
a mixing unit that mixes the image signal non-linearly smoothened by the non-linear smoothening unit with the input image signal;
a first correction coefficient calculation unit that calculates a gain correction coefficient, based on a mixture image signal mixed by the mixing unit;
a first compression processing unit that compresses a dynamic range of the input image signal by multiplying the input image signal by the gain correction coefficient calculated by the correction coefficient calculation unit;
a storage unit that stores temporarily the input image signal;
a second correction coefficient calculation unit that calculates a gain correction coefficient, based on the input image signal; and
a second compression processing unit that compresses the dynamic range of the input image signal by multiplying the input image signal read out from the storage means by the gain correction coefficient calculated by the second correction coefficient calculation unit.

17. An image processing apparatus comprising:
a non-linear smoothening unit that non-linearly smoothens an input image signal in horizontal and vertical directions while storing an edge component of the input image signal whose signal level varies;
a mixing unit that mixes the image signal non-linearly smoothened by the non-linear smoothening unit with the input image signal;
a first difference signal emphasis unit that subjects, to gradation conversion, a difference between a mixture image signal mixed by the mixing unit and the input image signal, and that adds the difference to an original not-smoothened image signal;
a storage unit that stores temporarily the input image signal; and
a second difference signal emphasis unit that subjects, to gradation conversion, a difference between the image signal non-linearly smoothened by the non-linear smoothening unit and the input image signal read out from the storage unit, and that adds the difference to an original not-smoothened image signal.

18. An image processing apparatus comprising:
a non-linear smoothening unit that non-linearly smoothens an input image signal in horizontal and vertical directions while storing an edge component of the input image signal whose signal level varies;
a mixing unit that mixes the image signal non-linearly smoothened by the non-linear smoothening unit with the input image signal;
a first correction coefficient calculation unit that calculates a gain correction coefficient, based on a mixture image signal mixed by the mixing unit;
a first compression processing unit that compresses a dynamic range of the input image signal by multiplying the input image signal by the gain correction coefficient calculated by the correction coefficient calculation unit;
a first difference signal emphasis unit that subjects, to gradation conversion, a difference between the mixture image signal mixed by the mixing unit and the input image signal, and that adds the difference to an original not-smoothened image signal;
a storage unit that stores temporarily the input image signal;
a second correction coefficient calculation unit that calculates a gain correction coefficient, based on the input image signal;
a second compression processing unit that compresses the dynamic range of the input image signal by multiplying the input image signal read out from the storage unit by the gain correction coefficient calculated by the second correction coefficient calculation unit; and
a second difference signal emphasis unit that subjects, to gradation conversion, a difference between the image signal non-linearly smoothened by the non-linear smoothening unit and the input image signal read out from the storage unit, and that adds the difference to an original not-smoothened image signal.
